(19) United States
(12) Patent Application Publication
(10) Pub. No.: US 2002/0137488 A1
(43) Pub. Date: Sep. 26, 2002

(54) Direct conversion receiver for performing phase correction upon change of the gain of low-noise amplifier

(76) Inventor: Masataka Mitama, Tokyo (JP)

Correspondence Address: McGinn & Gibb, PLLC, Suite 200, 8321 Old Courthouse Road, Vienna, VA, 22182-3817, US

(21) Appl. No.: 10/104,022

(22) Filed: Mar. 25, 2002

(30) Foreign Application Priority Data
Mar. 26, 2001 (JP) 2001-087938

(51) Int. Cl. H04B 1/26

(52) U.S. Cl. 455/324; 455/323

(57) ABSTRACT

A direct conversion receiver corrects the phase of a signal when the gain of a low-noise amplifier is switched. A complex multiplier sets, in advance therein, the amount Δ of a shift of the phase which is caused when the gain of the low-noise amplifier is switched. Depending on the gain of the low-noise amplifier which is switched by a gain switching signal, the complex multiplier corrects the phase of a baseband signal from an A/D converter by the preset amount Δ of the shift. By correcting a phase change in the low-noise amplifier which is caused when the gain of the low-noise amplifier is switched, the phase state of baseband I, Q signals can be held in a state prior to the switching of the gain to prevent the bit error rate (BER) of a received signal from being degraded.

### BACKGROUND OF THE INVENTION

1. Field of the Invention

The present invention relates to a direct conversion receiver for converting a received signal having a carrier frequency directly into a signal having a baseband frequency.

2. Description of the Related Art

Direct conversion receivers convert a carrier frequency directly into a baseband frequency without converting the carrier frequency first into an intermediate frequency (IF), and hence do not require any intermediate frequency filters. Since direct conversion receivers are made up of a reduced number of parts and can easily be constructed as an integrated circuit, efforts have been made to use them in practical applications. In recent years, many attempts have also been made to apply direct conversion receivers to multimode cellular phone receivers which are capable of receiving a plurality of systems as the frequency design is easy to make due to the absence of an image frequency.

One conventional direct conversion receiver is shown in FIG. 1 of the accompanying drawings. As shown in FIG. 1, the conventional direct conversion receiver comprises antenna 1, bandpass filter (BPF) 2, low-noise amplifier (LNA), bandpass filter (BPF) 4, quadrature filters 51, 52, variable-gain amplifiers 61, 62, A/D converters 71, 72, phase unit 8, local oscillator 9, despreader/demodulator 10, PN (Pseudorandom Noise) sequence acquisition unit 11, PN sequence tracking unit 12, and digital signal processor (DSP) 120.

It is assumed in the description of the conventional direct conversion receiver that a received signal is modulated according to a synchronous detection QPSK (Quadrature Phase Shift Keying) process which is a reception process used for W-CDMA (Wideband-CDMA) terminals.

Bandpass filters 2, 4 are filters for passing only a received signal of a carrier frequency. Low-noise amplifier 3 amplifies a signal which has passed through bandpass filter 2 with a gain selected depending on gain switching signal 101, and outputs the amplified signal. For example, if the gain of low-noise amplifier 3 can be switched between two values of 15 dB and −3 dB, then the gain of low-noise amplifier 3 is switched between 15 dB and −3 dB depending on the gain switching signal 101.

Local oscillator 9 generates a signal whose frequency has been controlled by despreader/demodulator 10 and outputs the generated signal. Phase unit 8 controls the phase of the signal generated by local oscillator 9, and generates two signals which are out of phase with each other by 90°. Quadrature mixers 51, 52 multiply the signal from bandpass filter 4 by the two signals generated by phase unit 8, thereby converting the output signal from low-noise amplifier 3 into an in-phase (I) component of a baseband signal and a quadrature (Q) component of a baseband signal. A/D converters 71, 72 convert output signals from quadrature mixers 51, 52 transmitted via respective variable-gain amplifiers 61, 62 into corresponding digital signals.

Despreader/demodulator 10 despreads and demodulates the digital signals generated by A/D converters 71, 72. PN sequence acquisition unit 11 carries out a process of keeping the phase difference between the PN code contained in the digital baseband signal from A/D converters 71, 72 and a PN code in the receiver within one chip. PN sequence tracking unit 12 carries out a process of eliminating the phase difference between the PN code in the digital baseband signal, whose phase difference has been kept within one chip by PN sequence acquisition unit 11, and the PN code in the receiver.

DSP 120 processes digital signals output from despreader/demodulator 10. DSP 120 also outputs a gain switching signal 101 for changing the gain of low-noise amplifier 3 discretely (i.e., stepwise) and a gain control signal 102 for controlling the gains of variable-gain amplifiers 61, 62, in order to keep the I and Q components of the baseband signals input to A/D converters 71, 72 at appropriate levels even when the level of the signal received by antenna 1 is changed.

Specifically, since the signal received by antenna 1 is amplified with the sum (total gain) of the gain of low-noise amplifier 3 and the gains of variable-gain amplifiers 61, 62 and then input to A/D converters 71, 72, DSP 120 controls the gains of amplifiers 3, 61, 62 thereby keeping the I and Q components of the baseband signals input to A/D converters 71, 72.

The basis on which the total gain of low-noise amplifier 3 and variable-gain amplifiers 61, 62 is adjusted by DSP 120 will be described below. If the levels of signals input to A/D converters 71, 72 exceeds an upper limit level for the A/D conversion process, then despreader/demodulator 10 fails to despread and demodulate data input thereto, and, as a result, the BER (Bit Error Rate) of data output from despreader/demodulator 10 is degraded. To avoid this drawback, DSP 120 monitors the level (I²+Q²)^{½} of the output signals of A/D converters 71, 72 which are input to despreader/demodulator 10. If the level (I²+Q²)^{½} does not reach a predetermined level, then DSP 120 adjusts the total gain of low-noise amplifier 3 and variable-gain amplifiers 61, 62 to adjust the levels of signals input to A/D converters 71, 72.

Operation of the conventional direct conversion receiver will be described below.

A modulated radio signal input from antenna 1 is transmitted successively through bandpass filter 2, low-noise amplifier 3, and bandpass filter 4 to quadrature mixers 51, 52, which convert the signal into an in-phase (I) component of a baseband signal and a quadrature (Q) component of a baseband signal.

The signal which is input to quadrature mixers 51, 52 is expressed by the following equation (1):

s(t)=A₁c(t+τ₁)b₁(t)cos(2πf_{c}t+θ)+A₁c(t+τ₁)b₂(t)sin(2πf_{c}t+θ) (1)

where A₁ is a constant, c(t) a PN code, b₁(t), b₂(t)=±1 data, f_{c} a carrier frequency, and θ a carrier phase.

With the carrier frequency f_{c} and the phase θ being assumed to be known, local oscillator 9 generates a signal cos(2πf_{c}t+θ). Phase unit 8 then generates two signals cos(2πf_{c}t+θ), sin(2πf_{c}t+θ) from the signal cos(2πf_{c}t+θ). Then, quadrature mixers 51, 52 perform a quadrature conversion process by multiplying the two signals generated by phase unit 8 by the signal represented by the equation (1), thereby producing baseband signals expressed by the following equations (2), (3):

I(t)=s(t)cos(2πf_{c}t+θ)=A₂c(t+τ₁)b₁(t) (2)

Q(t)=s(t)sin(2πf_{c}t+θ)=A₂c(t+τ₁)b₂(t) (3)

where A₂ is a constant.

The baseband signals expressed by the equations (2), (3) are amplified by respective variable-gain amplifiers 61, 62, then input to A/D converters 71, 72, and converted thereby into respective digital signals. Usually, the digital signals are 6- through 8-bit signals.

If the direct conversion receiver is a CDMA receiver, then it generates a PN sequence in synchronism with the received PN code sequence using the output signals from A/D converters 71, 72. Generally, a CDMA receiver is aware of a PN sequence for use in spreading data, but unaware of the code phase of the received signal.

Normally, a PN sequence is synchronized according to the following two processes:

1) PN sequence acquisition; and

2) PN sequence tracking.

In the first process of PN sequence acquisition, PN sequence acquisition unit 11 keeps the phase difference between the PN code contained in the digital baseband signal from A/D converters 71, 72 and the PN code in the receiver within one chip.

PN sequence acquisition unit 11 generates a local PN sequence c(t+τ) where |τ−τ₁|<αT_{c} (T_{c}: chip period, α: constant) within the receiver.

Specifically, PN sequence acquisition unit 11 searches a plurality of phase values for a local PN sequence phase τ which has the highest correlation to the input PN sequence.

When the phase difference between the local PN sequence and the input PN sequence falls within one chip, PN sequence tracking unit 12 comes into operation to eliminate the phase difference (τ=τ₁) in the second process of PN sequence tracking.

When the data are despread using a local PN sequence c(t+τ₁) thus obtained, the following signals are produced:

I′(t)=A₃b₁(t) (4)

Q′(t)=A₃b₂(t) (5)

Therefore, the data b₁(t+τ₁), b₂(t+τ₁) can be demodulated.

In the above description, it is premised that the carrier frequency f_{c} and the phase θ are known in advance. Actually, however, approximate values f_{c}′, θ of the carrier frequency f_{c} and the phase θ are generated, and using signals, given below, produced by spreading them,

I′(t)=A₃b₁(t)+O_{I}(fc′−f, θ′−θ) (6)

Q′(t)=A₃b₂(t)+O_{Q}(fc′−f, θ′−θ) (7)

the frequency and phase of local oscillator 9 are controlled in order to minimize the values of O_{I}(fc′−f, θ′−θ), O_{Q}(fc′−f, θ′−θ).

The demodulating function of the CDMA system has been described above. A process of demodulating original data from a received signal having a carrier frequency will hereafter be referred to as “synchronous demodulating process”.

In the direct conversion receiver, a received signal having a carrier frequency which is in an RF band is converted directly into a baseband frequency without being converted into an intermediate frequency. If the gain with which to amplify the received signal is changed only by variable-gain amplifiers 61, 62, then it is not possible to increase the dynamic range of a power level that can be received by the receiver. The direct conversion receiver as it is applied to a cellular phone system fails to have a sufficient dynamic range.

In the direct conversion receiver, generally, it is therefore customary to switch the gain of low-noise amplifier 3 discretely (i.e., stepwise) in order to maintain a dynamic range large enough for received signals that can be handled by the direct conversion receiver.

For example, it is assumed that the gain of low-noise amplifier 3 is switched between two values of 15 dB and −3 dB. Then the gain of low-noise amplifier 3 is switched between 15 dB and −3 dB depending on the gain switching signal 101.

However, when the gain of low-noise amplifier 3 is changed from 15 dB to −3 dB, the transit phase in low-noise amplifier 3 also changes.

Specifically, when the gain of low-noise amplifier 3 is switched, the equation (1) becomes:

s₁(t)=A₁c(t+τ₁)b₁(t)cos(2πf_{c}t+θ+Δ)+A₁c(t+τ₁)b₂(t)sin(2πf_{c}t+θ+Δ) (8)

where Δ: the amount of a shift of the transit phase (the difference between transit phases) in low-noise amplifier 3 upon switching of its gain.

At the time, the output signals of quadrature mixers 51, 52 are represented respectively by:

I₁(t)=s₁(t)cos(2πf_{c}t+θ)=A₂I(t)cos(Δ)+A₂Q(t)sin(Δ) (9)

Q₁(t)=s₁(t)cos(2πf_{c}t+θ)=A₂Q(t)sin(Δ)+A₂Q(t)sin(Δ) (10)

Using the equations (9), (10), a complex expression is given by the following equation (11):

I₁(t)+jQ₁(t)=(I(t)+jQ(t))exp(−jΔ) (11)

where exp ( ) indicates an exponential function.

The equation (11) shows that when the gain of low-noise amplifier 3 is switched, the IQ coordinate is rotated by −Δ in an IQ phase space diagram. FIG. 2 of the accompanying drawings shows an IQ phase space diagram of IQ coordinates before and after the gain of low-noise amplifier 3 is switched. Specifically, since when the gain of low-noise amplifier 3 is switched, the phase in low-noise amplifier 3 is also changed at the same time, the transit phases of the baseband signals I, Q are changed discretely, resulting in a degradation of the bit error rate (BER) of the received signal. While the synchronous demodulating process needs to be carried out again in order to keep the bit error rate (BER) of the received signal, the data is not demodulated normally during the synchronous demodulating process, and the BER is degraded.

### SUMMARY OF THE INVENTION

It is therefore an object of the present invention to provide a direct conversion receiver which prevents the bit error rate (BER) of a received signal from being degraded when the gain of a low-noise preamplifier is changed stepwise.

To achieve the above object, a direct conversion receiver according to the present invention has a low-noise amplifier, two quadrature mixers, two A/D converters, a phase correcting means, and a digital signal processor.

The low-noise amplifier amplifies a received signal having a carrier frequency with a gain switched based on an external command. The two quadrature mixers convert an output signal from the low-noise amplifier into baseband signals of an in-phase (I) component and a quadrature (Q) component. The two A/D converters convert baseband signals from the quadrature mixers into respective digital baseband signals. The phase correcting means sets, in advance therein, the amount of a shift of the transit phase of the signal having the carrier frequency which is caused when the gain of the low-noise amplifier is switched, and corrects the phases of the digital baseband signals of the in-phase (I) component and the quadrature (Q) component which are output from the A/D converters to cancel out the amount of the shift of the transit phase in synchronism with the switching of the gain of the low-noise amplifier. The digital signal processor processes digital signals which have been corrected in phase by the phase correcting means.

With the above arrangement, even when the gain of the low-noise amplifier is switched and the transit phase in the low-noise amplifier is changed, since the phase correcting means corrects the phase to cancel out the amount of the shift of the transit phase, the phase state of the baseband signals can be held in a state prior to the switching of the gain. Therefore, the synchronous demodulating process for the received signal does not need to be carried out again, and the bit error rate (BER) of the received signal is not degraded when the gain of the low-noise amplifier is switched.

According to the present invention, the phase correcting means comprises first and second correction signal memory means, first, second, third, and fourth multipliers, a subtractor, and an adder.

The correction signal memory means sets, in advance therein, the cosine values cos Δ of the amounts Δ of shifts of the transit phase, selects one of the cosine values depending on the gain to which the low-noise amplifier is switched, and outputs the selected cosine value as a signal cos Ψ for correcting the phase of a corrective quantity Ψ. The second correction signal memory means sets, in advance therein, the sine values sin Δ of the amounts Δ of shifts of the transit phase, selects one of the sine values depending on the gain to which the low-noise amplifier is switched, and outputs the selected sine value as a signal sin ψ for correcting the phase of the corrective quantity Ψ.

The first multiplier multiplies the digital baseband signal x(t) of the in-phase (I) component which is input thereto by the signal cost output from the first correction signal memory means. The second multiplier multiplies the digital baseband signal y(t) of the quadrature (Q) component which is input thereto by the signal sin ψ output from the second correction signal memory means. The third multiplier multiplies the digital baseband signal x(t) of the in-phase (I) component which is input thereto by the signal sin ψ output from the second correction signal memory means. The fourth multiplier multiplies the digital baseband signal y(t) of the quadrature (Q) component which is input thereto by the signal cos ψ output from the first correction signal memory means. The subtractor subtracts a signal y(t)sin ψ generated by the second multiplier from a signal x(t)cos ψ generated by the first multiplier and outputs the difference as a corrected signal {x(t)cos Ψ−y(t)sin Ψ} of the in-phase (I) component. The adder adds a signal x(t)sin ψ generated by the third multiplier and a signal y(t)cos Ψ generated by the fourth multiplier to each other and outputs the sum as a corrected signal {x(t)sin Ψ+y(t)cos Ψ} of the quadrature (Q) component.

According to the present invention, the digital signal processor may demodulate the digital baseband signals according to a synchronous or asynchronous detection process.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of a conventional direct conversion receiver;

FIG. 2 is an IQ phase space diagram of IQ coordinates before and after the gain of a low-noise amplifier in the conventional direct conversion receiver shown in FIG. 1 is switched;

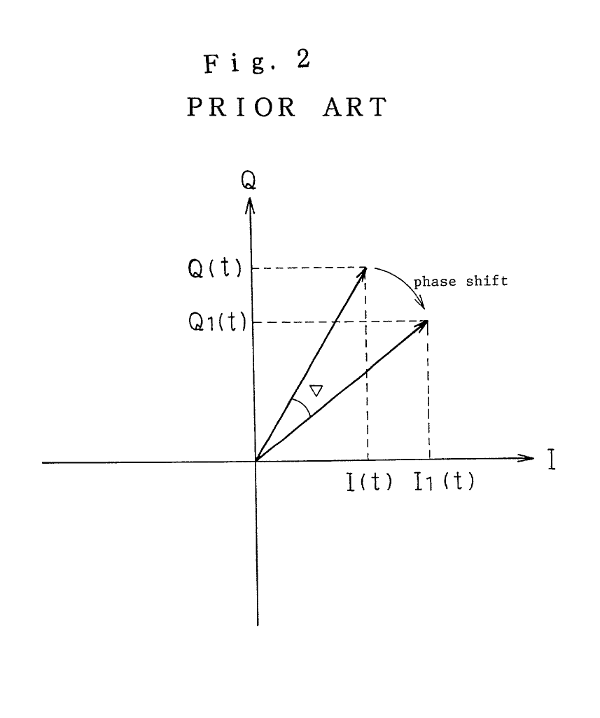

FIG. 3 is a block diagram of a direct conversion receiver according to a first embodiment of the present invention;

FIG. 4 is a block diagram of a complex multiplier in the direct conversion receiver shown in FIG. 3;

FIG. 5 is a block diagram of a direct conversion receiver according to a second embodiment of the present invention; and

FIG. 6 is a block diagram of a complex multiplier in the direct conversion receiver shown in FIG. 5.

### DETAILED DESCRIPTION OF THE PREFERRED EMBODIMENTS

1st Embodiment:

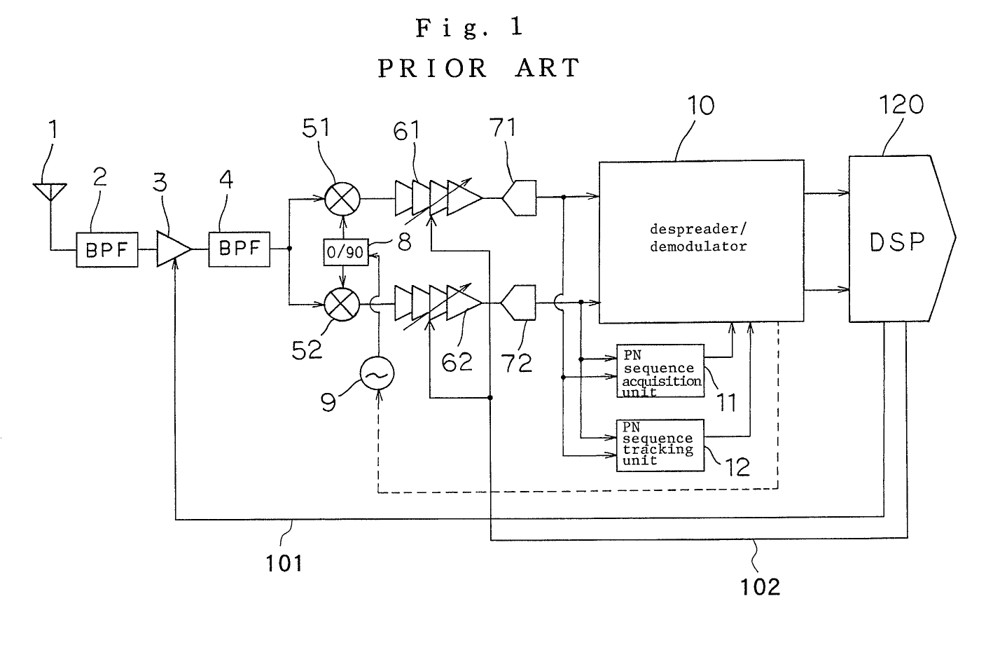

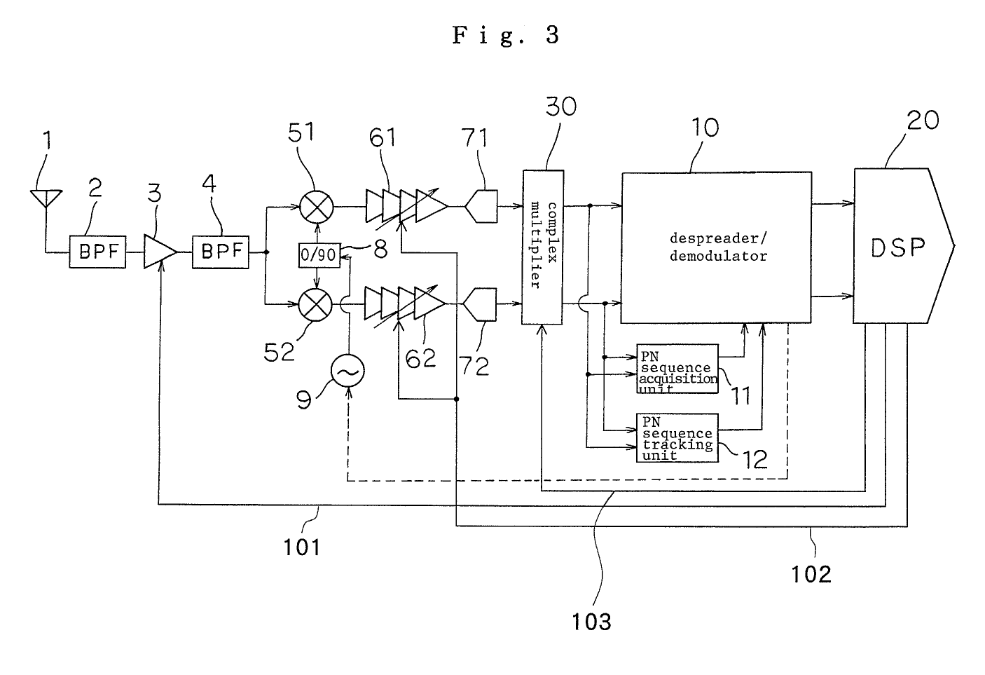

As shown in FIG. 3, a direct conversion receiver according to a first embodiment of the present invention differs from the conventional direct conversion receiver shown in FIG. 1 in that a complex multiplier 30 shown in FIG. 3 is newly connected between A/D converters 71, 72 and despreader/demodulator 10 which are disposed in the baseband signal I, Q paths, and DSP 120 shown in FIG. 1 is replaced with DSP 20 shown in FIG. 3.

According to the first embodiment, the amount Δ of a shift of the transit phase which is caused when the gain of low-noise amplifier 3 is switched from 15 dB to −3 dB is measured in advance, and set in complex multiplier 30. Complex multiplier 30 operates as a phase correcting means for correcting the phase to cancel out the amount Δ of a shift of the transit phase in synchronism with the switching of the gain of low-noise amplifier 3 for thereby holding the phase state of baseband I, Q signals in a state prior to the switching of the gain to prevent the bit error rate (BER) of the received signal from being degraded.

DSP 20 according to the present embodiment differs from DSP 120 in the conventional direct conversion receiver shown in FIG. 1 in that it outputs complex multiplier control signal 103. DSP 20 switches complex multiplier control signal 103 in timed relation to the switching of the gain of low-noise amplifier 3 based on gain switching signal 101 to determine whether complex multiplier 30 is to correct the phase or not.

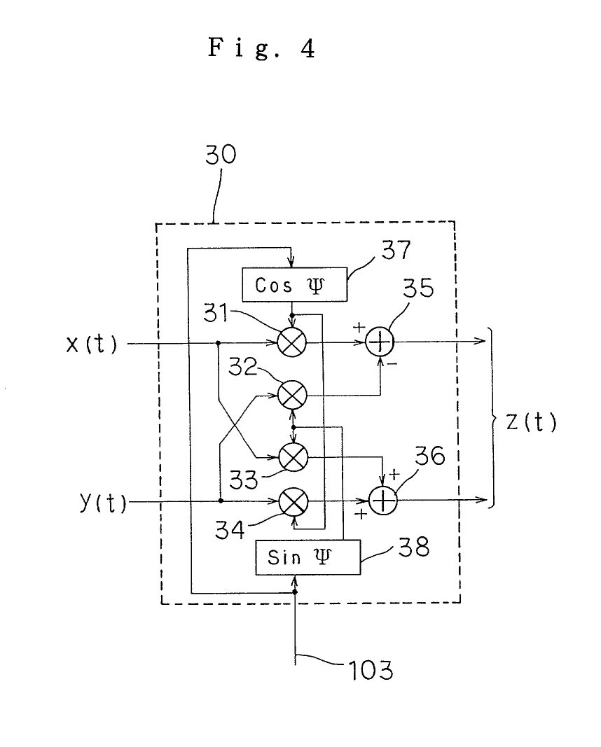

As shown in FIG. 4, complex multiplier 30 comprises multipliers 31 through 34, subtractor 35, adder 36, and correction signal registers 37, 38.

Signal x(t) of an in-phase (I) component and signal y(t) of a quadrature (Q) component are input to complex multiplier 30, which corrects the phases of those signals and outputs a phase-corrected signal of an in-phase (I) and a phase-corrected signal of a quadrature (Q) component.

Cosine value cos Δ of the amount Δ of a shift of the transit phase which is caused when the gain of low-noise amplifier 3 is switched is set in advance in correction signal register 37. If complex multiplier control signal 103 indicates that complex multiplier 30 is not to correct the phase, then correction signal register 37 outputs a signal indicating cos 0=1. If complex multiplier control signal 103 indicates that complex multiplier 30 is to correct the phase, then correction signal register 37 outputs a signal indicating cos Δ.

Sine value sin Δ of the amount Δ of a shift of the transit phase which is caused when the gain of low-noise amplifier 3 is switched is set in advance in correction signal register 38. If complex multiplier control signal 103 indicates that complex multiplier 30 is not to correct the phase, then correction signal register 38 outputs a signal indicating sin 0=0. If complex multiplier control signal 103 indicates that complex multiplier 30 is to correct the phase, then correction signal register 38 outputs a signal indicating sin Δ.

Specifically, correction signal registers 37, 38, which serve as a correction signal memory means, switch the value of corrective quantity Ψ to 0 or Δ depending on complex multiplier control signal 103 and output cos Ψ, sin Ψ, respectively, of corrective quantity Ψ for correcting the phase. Therefore, signals output from respective correction signal registers 37, 38 will hereinafter be represented by cos Ψ, sin ψ, respectively.

Multiplier 31 multiplies signal x(t) of an in-phase (I) component which is input thereto by signal cos ψ output from correction signal register 37. Multiplier 32 multiplies signal y(t) of a quadrature (Q) component which is input thereto by signal sin Ψ output from correction signal register 38. Multiplier 33 multiplies signal x(t) of an in-phase (I) component which is input thereto by signal sin ψ output from correction signal register 38. Multiplier 34 multiplies signal y(t) of a quadrature (Q) component which is input thereto by signal cos ψ output from correction signal register 37.

Subtractor 35 subtracts signal y(t)sin ψ generated by multiplier 32 from signal x(t)cos ψ generated by multiplier 31, and outputs the difference as corrected signal {x(t)cos Ψ−y(t)sin Ψ} of an in-phase (I) component, and adder 36 adds signal x(t)sin ψ generated by multiplier 33 and signal y(t)cos ψ generated by multiplier 34 to each other and outputs the sum as corrected signal {x(t)sin Ψ+y(t)cos Ψ} of a quadrature (Q) component.

As described above, when signals x(t), y(t) are input to complex multiplier 30, complex multiplier 30 outputs signals {x(t)cos Ψ+y(t)sin Ψ}, {y(t)cos Ψ+x(t)sin Ψ}. A complex expression of these output signals is given as follows:

z (t)=x(t)cos Ψ+y(t)sin Ψ+j{y(t)cos Ψ+x(t)sin Ψ}={x(t)+jy(t)}×exp(jψ) (12)

Operation of the direct conversion receiver according to the first embodiment will be described below.

First, it is assumed that the gain of low-noise amplifier 3 is 15 dB. In this case, the corrective quantity ψ is ψ=0, and correction signal register 37 outputs a signal indicating cos 0=1 and correction signal register 38 outputs a signal indicating sin 0=0.

Therefore, by placing x(t)=I(t), y(t)=Q(t), and ψ=0 in the equation (12), the complex expression of a signal output from complex multiplier 30 is given as follows:

z(t)=I(t)+jQ(t) (13)

In this case, complex multiplier 30 does not correct the phase.

It is now assumed that the gain of low-noise amplifier 3 is −3 dB. In this case, since the gain of low-noise amplifier 3 is switched, the transit phase is shifted by Δ, and the signals output from A/D converters 71, 72 are changed from I(t), Q(t) to I₁(t), Q₁(t), respectively. In complex multiplier 30, correction signal registers 37, 38 output signals sin Δ, cos Δ, respectively, from a signal indicating the corrective quantity ψ=Δ, sin 0=0, cos 0=1.

By placing x(t)=I₁(t)=I(t)exp(−jΔ), y(t)=Q₁(t)=Q(t)exp(−jΔ), ψ=Δ in the equation (12), the complex expression of a signal output from complex multiplier 30 is given as follows:

z(t)=(I₁(t)+jQ₁(t))×exp(jΔ) =(I(t)exp(−jΔ)+jQ(t)exp(−jΔ))×exp(jΔ) =I(t)+jQ(t) (14)

Consequently, when the corrective quantity of complex multiplier 30 is changed from 0 to Δ to correct the phase in synchronism with the switching of the gain of low-noise amplifier 3, the phase state of the baseband signals output from complex multiplier 30 becomes the same before and after the gain is switched as indicated by the equations (13), (14). In the direct conversion receiver according to the present embodiment, therefore, since the phase state of the baseband I, Q signals can be held in the state prior to the switching of the gain by correcting a phase change in low-noise amplifier 3 which is caused when the gain of low-noise amplifier 3 is switched, the above “synchronous demodulating process” does not need to be carried out again. Therefore, the bit error rate (BER) of the received signal is not degraded when the gain of low-noise amplifier 3 is switched.

In the present invention, the gain switching signal 101 for switching the gain of low-noise amplifier 3 and complex multiplier control signal 103 for controlling the phase correction for complex multiplier 30 are independent of each other. However, the gain of low-noise amplifier 3 may be switched and complex multiplier 30 may be controlled by a single signal.

2nd Embodiment:

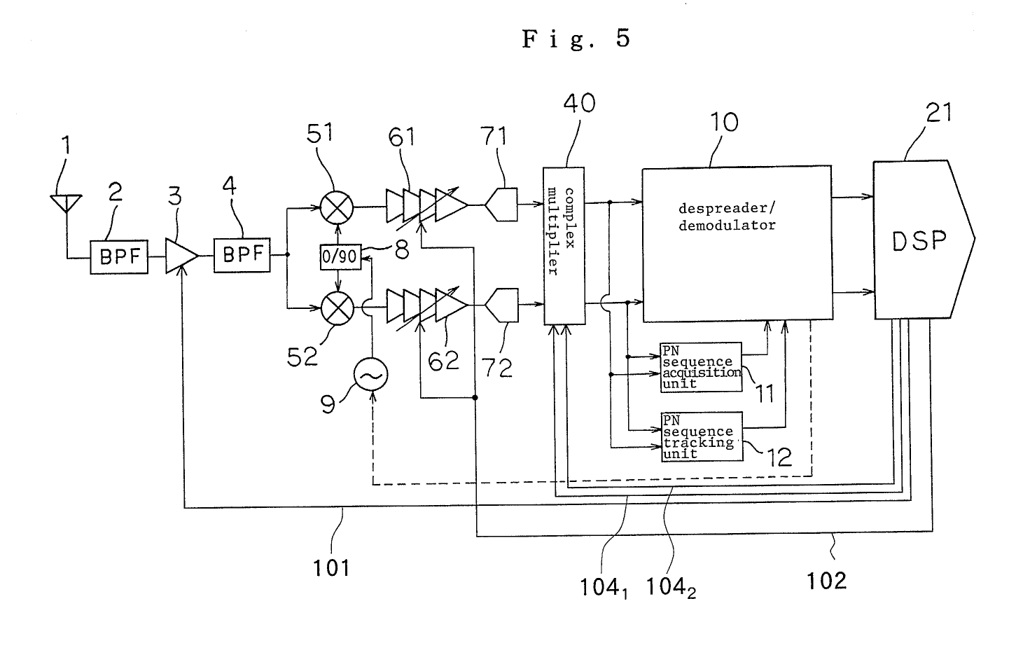

A direct conversion receiver according to a second embodiment of the present invention will be described below. FIG. 5 shows in block form the direct conversion receiver according to the second embodiment. Those parts of the direct conversion receiver shown in FIG. 5 which are identical to those of the direct conversion receiver shown in FIG. 3 are denoted by identical reference characters, and will not be described in detail below.

In the direct conversion receiver according to the first embodiment, the amount Δ of a shift of the transit phase which is caused when the gain of low-noise amplifier 3 is switched is set in advance in complex multiplier 30. According to the second embodiment, however, the amount Δ of a shift of the transit phase is set in advance in a DSP, and the DSP generates a correction signal.

As shown in FIG. 5, the direct conversion receiver according to the second embodiment differs from the direct conversion receiver according to the first embodiment in that complex multiplier 30 shown in FIG. 3 is replaced with complex multiplier 40, and DSP 20 shown in FIG. 3 is replaced with DSP 21.

According to the second embodiment, the amount Δ of a shift of the transit phase of the carrier signal which is caused when the gain of low-noise amplifier 3 is switched is set in advance in DSP 21. If the gain of low-noise amplifier 3 is set to 15 dB, then DSP 21 outputs a signal indicating cos 0=1 and a signal indicating sin 0=0 respectively as correction signals 104₁, 104₂. If the gain of low-noise amplifier 3 is set to −3 dB, then DSP 21 outputs a signal indicating cos Δ and a signal indicating sin Δ respectively as correction signals 104₁, 104₂. Specifically, if a corrective quantity ψ is used to correct the phase, then DSP 21 outputs a signal indicating cos ψ as correction signal 104₁, and a signal indicating sin ψ as correction signal 104₂. DSP 21 operates in the same manner as DSP 20 according to the first embodiment except that DSP 21 outputs correction signals 104₁, 104₂ instead of complex multiplier control signal 103.

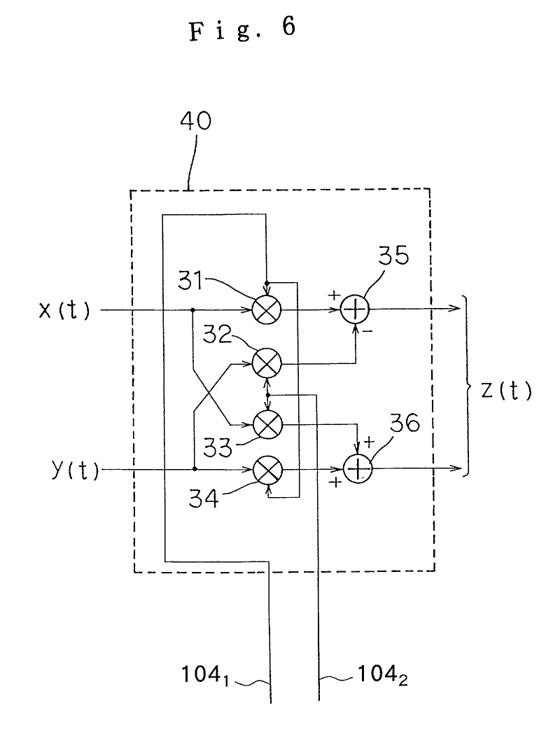

As shown in FIG. 6, complex multiplier 40 of direct conversion receiver according to the second embodiment comprises multipliers 31 through 34, subtractor 35, and adder 36, and is similar to complex multiplier 30 according to the first embodiment shown in FIG. 4 except that correction signal registers 37, 38 are dispensed with.

According to the second embodiment, multiplier 31 multiplies signal x(t) of an in-phase (I) component which is input thereto by correction signal 104₁, and multiplier 32 multiplies signal y(t) of a quadrature (Q) component which is input thereto by correction signal 104₂. Multiplier 33 multiplies signal x(t) of an in-phase (I) component which is input thereto by correction signal 104₂, and multiplier 34 multiplies signal y(t) of a quadrature (Q) component which is input thereto by correction signal 104₁.

Complex multiplier 40 operates to correct the phase in the same manner as complex multiplier 30 according to the first embodiment. Therefore, operation of complex multiplier 40 will not be described in detail below.

In the direct conversion receiver according to the second embodiment, as with the first embodiment, since the phase state of the baseband I, Q signals can be held in the state prior to the switching of the gain by correcting a phase change in low-noise amplifier 3 which is caused when the gain of low-noise amplifier 3 is switched, the bit error rate (BER) of the received signal is not degraded when the gain of low-noise amplifier 3 is switched.

The first and second embodiments described above are applied to a synchronous detection QPSK process for W-CDMA systems. However, the present invention is applicable to general communication systems which employ a synchronous detection process.

While the first and second embodiments are applicable to general communication systems which employ a synchronous detection process, the present invention is not limited to such communication systems, but is also applicable to modulation processes such as π/4QPSK, GMSK (Gaussian filtered Minimum Shift Keying) processes which are an asynchronous detection process.

In the first and second embodiments, the gain of low-noise amplifier 3 is switched between two values of 15 dB and −3 dB. However, the present invention is not limited to the switching of the gain between two values of 15 dB and −3 dB, but may be applied to the switching of the gain between three or more values providing transit phases depending on the phase values which are measured in advance. For example, though the corrective quantity ψ for correcting the phase is selected as 0 or Δ in the first and second embodiments, if the amounts of shifts of the transit phase of the carrier signal which is caused when the gain of low-noise amplifier 3 is switched are represented by al, Δ₁, Δ₂, Δ₃, . . . , then the corrective quantity ψ for correcting the phase depending on the switched gain of low-noise amplifier 3 may be selected as 0 or between Δ₁, Δ₂, Δ₃, . . . for phase correction.

While preferred embodiments of the present invention have been described using specific terms, such description is for illustrative purposes only, and it is to be understood that changes and variations may be made without departing from the spirit or scope of the appended claims.

What is claimed is:

1. A direct conversion receiver for converting a carrier frequency directly into a baseband frequency to receive a signal, comprising:
a low-noise amplifier for amplifying a received signal having a carrier frequency with a gain switched based on an external command;
two quadrature mixers for converting an output signal from said low-noise amplifier into baseband signals of an in-phase (I) component and a quadrature (Q) component;
two A/D converters for converting baseband signals from said quadrature mixers into respective digital baseband signals;
phase correcting means for setting, in advance therein, the amount of a shift of the transit phase of the signal having the carrier frequency which are caused when the gain of said low-noise amplifier is switched, and correcting the phases of the digital baseband signals of the in-phase (I) component and the quadrature (Q) component which are output from said A/D converters to cancel out said amount of the shift of the transit phase in synchronism with the switching of the gain of said low-noise amplifier; and
a digital signal processor for processing digital signals which have been corrected in phase by said phase correcting means.

2. A direct conversion amplifier according to claim 1, wherein said phase correcting means comprises:
first correction signal memory means for setting, in advance therein, the cosine values cos Δ of said amounts Δ of shifts of the transit phase, selecting one of the cosine values depending on the gain to which said low-noise amplifier is switched, and outputting the selected cosine value as a signal cos ψ for correcting the phase of a corrective quantity ψ;
second correction signal memory means for setting, in advance therein, the sine values sin Δ of said amounts Δ of shifts of the transit phase, selecting one of the sine values depending on the gain to which said low-noise amplifier is switched, and outputting the selected sine value as a signal sin ψ for correcting the phase of the corrective quantity ψ;
a first multiplier for multiplying the digital baseband signal x(t) of the in-phase (I) component which is input thereto by the signal cos ψ output from said first correction signal memory means;
a second multiplier for multiplying the digital baseband signal y(t) of the quadrature (Q) component which is input thereto by the signal sin ψ output from said second correction signal memory means;
a third multiplier for multiplying the digital baseband signal x(t) of the in-phase (I) component which is input thereto by the signal sin ψ output from said second correction signal memory means;
a fourth multiplier for multiplying the digital baseband signal y(t) of the quadrature (Q) component which is input thereto by the signal cos ψ output from said first correction signal memory means;
a subtractor for subtracting a signal y(t)sin ψ generated by said second multiplier from a signal x(t)cos ψ generated by said first multiplier and outputting the difference as a corrected signal {x(t)cos ψ−y(t)sin ψ} of the in-phase (I) component; and
an adder for adding a signal x(t)sin ψ generated by said third multiplier and a signal y(t)cos ψ generated by said fourth multiplier to each other and outputting the sum as a corrected signal {x(t)sin ψ+y(t)cos ψ} of the quadrature (Q) component.

3. A direct conversion receiver for converting a carrier frequency directly into a baseband frequency to receive a signal, comprising:
a low-noise amplifier for amplifying a received signal having a carrier frequency with a gain switched based on an external command;
two quadrature mixers for converting an output signal from said low-noise amplifier into baseband signals of an in-phase (I) component and a quadrature (Q) component;
two A/D converters for converting baseband signals from said quadrature mixers into respective digital baseband signals;
phase correcting means for correcting the phases of the digital baseband signals of the in-phase (I) component and the quadrature (Q) component which are output from said A/D converters to cancel out the amount of a shift of the transit phase of the signal having the carrier frequency in synchronism with the switching of the gain of said low-noise amplifier, using a first correction signal cos ψ which represents the cosine value of a corrective quantity ψ for correcting the amount of the shift of the transit phase and a second correction signal sin ψ which represents the sine value of the corrective quantity ψ for correcting the amount of the shift of the transit phase; and
a digital signal processor for setting, in advance therein, the amounts of shifts of the transit phase, selecting a corrective quantity ψ depending on the gain to which said low-noise amplifier is switched, outputting the cosine value of the corrective quantity ψ as said first correction signal cos ψ, outputting the sine value of the corrective quantity ψ as said second correction signal sin ψ, and processing the digital baseband signals corrected in phase by said phase correcting means.

4. A direct conversion receiver according to claim 3, wherein said phase correcting means comprises:
a first multiplier for multiplying the digital baseband signal x(t) of the in-phase (I) component which is input thereto by said first correction signal cos ψ;
a second multiplier for multiplying the digital baseband signal y(t) of the quadrature (Q) component which is input thereto by said second correction signal sin ψ;
a third multiplier for multiplying the digital baseband signal x(t) of the in-phase (I) component which is input thereto by said second correction signal sin ψ;
a fourth multiplier for multiplying the digital baseband signal y(t) of the quadrature (Q) component which is input thereto by the first correction signal cos ψ;
a subtractor for subtracting a signal y(t)sin ψ generated by said second multiplier from a signal x(t)cos ψ generated by said first multiplier and outputting the difference as a corrected signal {x(t)cos ψ−y(t)sin ψ} of the in-phase (I) component; and
an adder for adding a signal x(t)sin ψ generated by said third multiplier and a signal y(t)cos ψ generated by said fourth multiplier to each other and outputting the sum as a corrected signal {x(t)sin ψ+y(t)cos ψ} of the quadrature (Q) component.

5. A direct conversion receiver according to claim 1, wherein said digital signal processor demodulates said digital baseband signals according to a synchronous detection process.

6. A direct conversion receiver according to claim 2, wherein said digital signal processor demodulates said digital baseband signals according to a synchronous detection process.

7. A direct conversion receiver according to claim 3 , wherein said digital signal processor demodulates said digital baseband signals according to a synchronous detection process.

8. A direct conversion receiver according to claim 4, wherein said digital signal processor demodulates said digital baseband signals according to a synchronous detection process.

9. A direct conversion receiver according to claim 1, wherein said digital signal processor demodulates said digital baseband signals according to an asynchronous detection process.

10. A direct conversion receiver according to claim 2, wherein said digital signal processor demodulates said digital baseband signals according to an asynchronous detection process.

11. A direct conversion receiver according to claim 3, wherein said digital signal processor demodulates said digital baseband signals according to an asynchronous detection process.

12. A direct conversion receiver according to claim 4, wherein said digital signal processor demodulates said digital baseband signals according to an asynchronous detection process.
